(19) United States
(12) Patent Application Publication
(10) Pub. No.: US 2002/0083599 A1
(43) Pub. Date: Jul. 4, 2002

(54) Sod cutter blade

(76) Inventor: Yaron Nachshon, D.N. Harmovil (IL)

Correspondence Address: BRUCE E. LILLING, LILLING & LILLING P.C., P.O. BOX 560, GOLDEN BRIDGE, NY, 10526, US

(21) Appl. No.: 10/046,675

(22) Filed: Jan. 16, 2002

(30) Foreign Application Priority Data
Dec. 28, 2000 (IL) 140601/02

(51) Int. Cl. B26B 9/00

(52) U.S. Cl. 30/353; 76/104.1

(57) ABSTRACT

The present invention relates to a non-welded sod cutter blade prepared from one unit comprising a central blade and two sided blades, and to a process for preparing a sod cutter blade as described above generally comprising the steps of forming an appropriate one-piece planar shape comprising a central blade and two sided blades; heating each of the areas between the two sided blades and the central blade; and bending each of the two sided blades out of the plane of the central blade; said two sided blades being bent in the direction of one facing the other. the product is optionally further hardened, and is optionally further tempered.

### FIELD OF THE INVENTION

The field of the invention is agriculture tools.

### BACKGROUND OF THE INVENTION

Sod cutter blades are well known in the art, and are used to cut slabs of ready grass in the industry. The blade is made in many cases of carbon steel, and is mounted on a housing in a specially designed combine hauled by a tractor. The blade is inserted mechanically under the sod's roots and when the tractor moves forward the sod layer is detached in a peeling-like fashion. The final product is sold to the end customer as slabs or rolls. The blade can also be mounted on a manual motorized combine operated by a walking person who can keep the equipment moving in the correct direction.

One type of a sod cutter blade (SCB) is made of steel and comprises three main components:

1) a central blade used to “peel” the layer of grass from the soil on which it grows; and

2) two side blades used to cut through the layer of grass, one on each side to thus determine the width of the sod strip.

Said three components are connected by means of welding. However, due to the great stress imposed on said SCB, the lifetime of said SCB is shortened. Thus, a need for a resistant SCB suitable for use in the stressful field of sod cutting remains.

### SUMMARY OF THE INVENTION

It has been surprisingly found that a SCB having a central blade and two sided blades can be prepared from one “mother” piece according to the process that will be described hereinafter, and, thus, the drawback of the welded SCB of the prior art is avoided.

Thus, according to one aspect, the present invention relates to a non-welded sod cutter blade prepared from one unit comprising a central blade and two sided blades.

According to one embodiment, said sod cutter blade is substantially as illustrated in drawing no. 1

According to another aspect, the present invention relates to a process for preparing a sod cutter blade as described above comprising the steps of:

One) forming an appropriate one-piece planar shape comprising a central blade and two sided blades;

Two) heating each of the areas between the two sided blades and the central blade; and

Three) bending each of the two sided blades out of the plane of the central blade; said two sided blades being bent in the direction of one facing the other;

Four) the product of step (c) is optionally further hardened;

Five) the product of step (d) is optionally further tempered.

According to one embodiment, the two side-blades are bent at an angle of about 90° each in respect to the central blade.

According to one embodiment, the sod cutting blade is made of suitable materials including steel alloys, carbon steels, cast steels, stainless steels (SST), and hard plastics.

According to one embodiment, when the sod cutting blade is made of steel, the bending step is performed at a temperature of between about 800° C. and about 830° C.

According to one embodiment, the hardening step is performed at a temperature of about 850° C.

According to one embodiment, the tempering step is performed at a temperature of about 350° C.

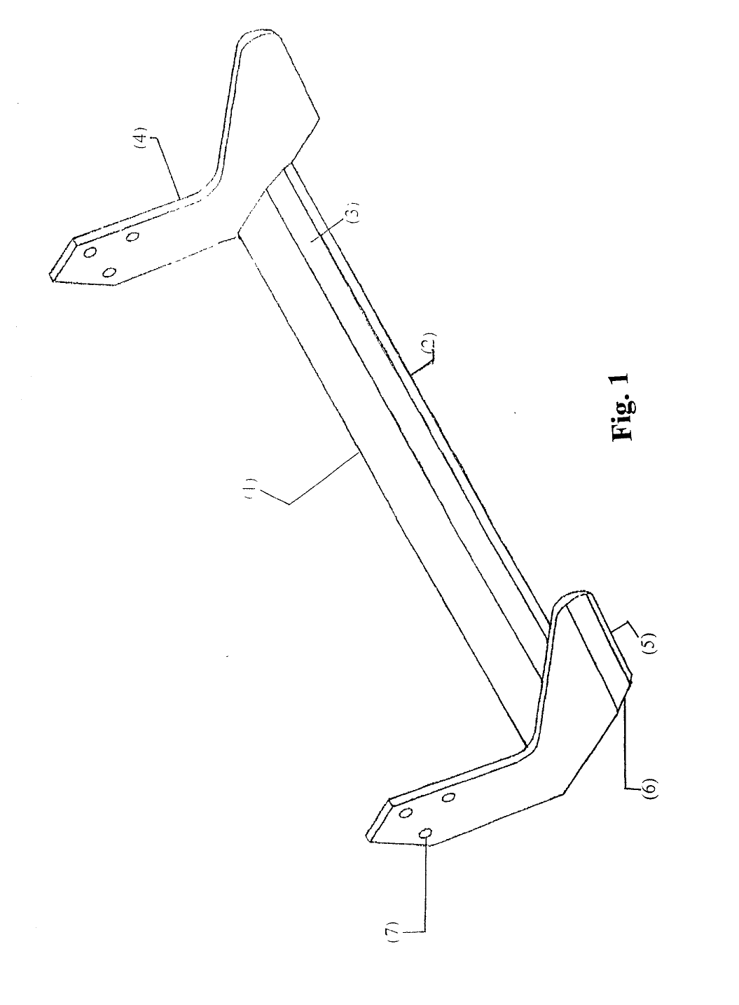

FIG. 1 represents a perspective view of the SCB of the present invention. In which numeral 1 represents a central blade; numeral 2 represents a front blade; numeral 3 represents the release angle for the front blade; numeral 4 represents a side arm; numeral 5 represents a blade of the side arm; numeral 6 represents the release angle for the blade of the side arm; and numeral 7 represents a drilling for the blade holding screw.

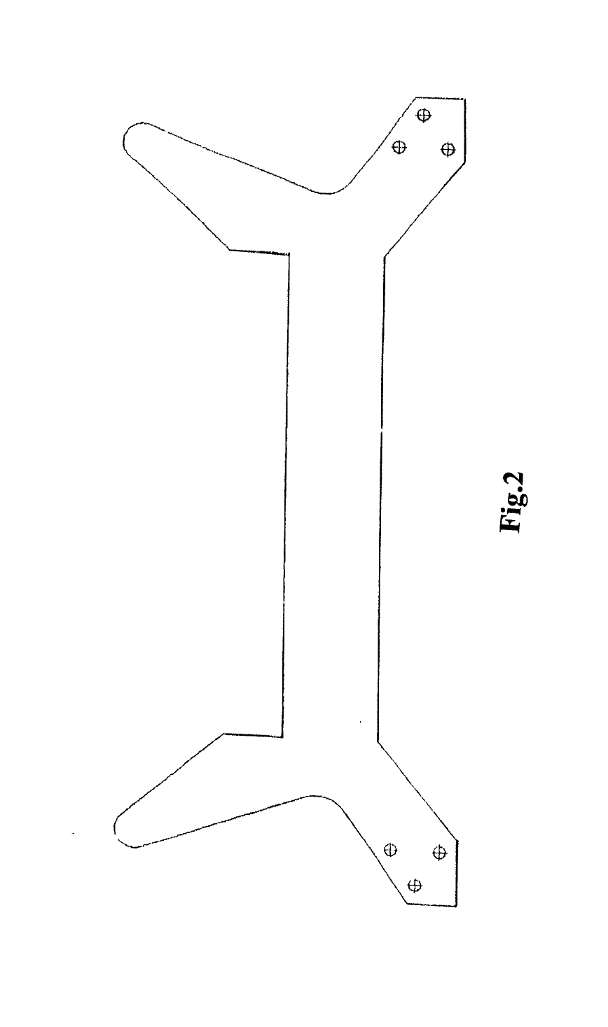

FIG. 2 represents a front view of the planar, one piece, blade prior bending to the SCB of the present invention.

The SCB of the present invention is made of one piece as opposed to the three piece SCB of the prior art. Being made of one piece, the SCB of the present invention needs not to be welded at any of the two attachments as in the prior art SCB's.

Thus, the SCB of the present invention has not the weak points as in the prior art SCB.

While embodiments of the invention have been described by way of description, it will be apparent that the invention may be carried out with many modifications, variations and adaptations, without departing from its spirit or exceeding the scope of the claims.

It should be understood that some modification, alteration and substitution is anticipated and expected from those skilled in the art without departing from the teachings of the invention. Accordingly, it is appropriate that the following claims be construed broadly and in a manner consistent with the scope and spirit of the invention.

1) A non-welded sod cutter blade prepared from one unit comprising a central blade and two sided blades.

2) A sod cutter blade according to claim 1 substantially as illustrated in drawing no. 1

3) A sod cutter blade according to claim 1, in which two side-blades are bent at an angle of about 90° each in respect to the central blade.

4) A sod cutter blade according to claim 1, which is made of materials selected from the group consisting of steel alloys, carbon steels, cast steels, stainless steels, and hard plastics.

5) A sod cutter blade according to claim 1, which is made of steel.

6) A sod cutter blade according to claim 1, which is made of steel and in which the two sided blades are bent at an angle of about 90° each.

7) A process for preparing a non welded sod cutter comprising the steps of:
One) forming an appropriate one-piece planar shape comprising a central blade and two sided blades;
Two) heating each of the areas between the two sided blades and the central blade; and
Three) bending each of the two sided blades out of the plane of the central blade; said two sided blades being bent in the direction of one facing the other.

8) A process according to claim 7 in which the sod cutting blade is made of steel, and the bending step is performed at a temperature of between about 800° C. and about 830° C.

9) A process for preparing a non welded sod cutter comprising the steps of:
One) forming an appropriate one-piece planar shape comprising a central blade and two sided blades;
Two) heating each of the areas between the two sided blades and the central blade;
Three) bending each of the two sided blades out of the plane of the central blade; said two sided blades being bent in the direction of one facing the other; and
Four) the product of step (c) is hardened.

10) A process according to claim 9 in which the sod cutting blade is made of steel, and the bending step is performed at a temperature of between about 800° C. and about 830° C.

11) A process according to claim 9 in which the sod cutting blade is made of steel, and the hardening step is performed at a temperature of about 850° C.

12) A process for preparing a non welded sod cutter comprising the steps of:
One) forming an appropriate one-piece planar shape comprising a central blade and two sided blades;
Two) heating each of the areas between the two sided blades and the central blade;
Three) bending each of the two sided blades out of the plane of the central blade; said two sided blades being bent in the direction of one facing the other;
Four) the product of step (c) is hardened; and
Five) the product of step (d) is further tempered

13) A process according to claim 12 in which the sod cutting blade is made of steel, and the bending step is performed at a temperature of between about 800° C. and about 830° C.

14) A process according to claim 12 in which the sod cutting blade is made of steel, and the hardening step is performed at a temperature of about 850° C.

15) A process according to claim 12 in which the sod cutting blade is made of steel, and the tempering step is performed at a temperature of about 350° C.
